(19) United States
(12) Patent Application Publication
(10) Pub. No.: US 2006/0123760 A1
(43) Pub. Date: Jun. 15, 2006

(54) Lawnmower with projections for lifting grass and method of cutting grass

(76) Inventor: Robert W. Glasscock, Fort Wayne, IN (US)

Correspondence Address: George Pappas;Suite 300, 919 S. Harrison Street, Fort Wayne, IN, 46802, US

(21) Appl. No.: 11/001,380

(22) Filed: Dec. 1, 2004

(51) Int. Cl. A01D 34/64

(52) U.S. Cl. 56/17.3

(57) ABSTRACT

A lawnmower having a grass cutting mechanism mounted on a body. The lawnmower is supported by a plurality of wheels. A plurality of a flexible projections are located on the body forward of the cutting mechanism and projecting downward from the body. The flexible projections, which may be bristles, can be used to engage the downwardly bent grass of a wheel track to thereby at least partially lift the grass immediately before it is cut by the lawnmower. A method of cutting grass is also provided wherein a strip of uncut grass is bent toward the ground as a first swath of grass is being cut. The bent strip of uncut grass is at least partially lifted with a plurality of downward projecting members immediately prior to cutting as a second swath of grass that includes the bent strip is being cut.

### BACKGROUND OF THE INVENTION

1. Field of the Invention

The present invention relates to lawnmowers and, more particularly, to a lawnmower that cuts grass at a consistent height.

2. Description of the Related Art

It is generally desirable after cutting a lawn with a mower that the lawn have a consistent height. When mowing a lawn, the wheels on one side of the mower will typically be located in an uncut portion of the lawn and may bend a strip of the uncut grass downwardly leaving a “wheel track”.

If the downwardly bent grass forming the wheel track remains bent or compressed when that portion of the lawn is cut, the wheel track will be noticeable within a few days after the bent grass once again stands up and projects above the surrounding grass. These strips of taller grass can mar the appearance of the lawn. This problem is most pronounced when the grass being cut is partially wet.

The cutting blades of many mowers will generate an air flow that is sufficient to stand up dry grass that has been bent down to form such wheel tracks and thereby avoid the problem of uncut strips caused by such wheel tracks. In recent years, however, mulching lawnmowers have grown in popularity. Instead of discharging the grass cuttings into a bag attached to the mower or onto an adjacent part of the lawn, a mulching lawnmower recirculates the grass cuttings within the mower deck where the cuttings may be reduced in size by contact with the blades and are eventually discharged downwardly onto the ground. It has been noticed by the present inventor that many of these mulching lawnmowers fail to adequately cut the grass forming such wheel tracks even when the grass is dry or when the mower is equipped with “high lift blades”.

An improved lawnmower that more adequately addresses the problem presented by such wheel tracks is desirable.

### SUMMARY OF THE INVENTION

The present invention provides lawnmower with downwardly projecting flexible members or bristles that are positioned on the lawnmower to lift the bent grass forming a wheel track prior to that grass being cut by the mower. This invention may be used with mulching mowers as well as other mowers and forms of grass cutting instruments.

The invention comprises, in one form thereof, a lawnmower that includes a body and a cutting mechanism mounted on the body that is adapted to cut grass. A plurality of wheels mounted on the body are used to support the lawnmower. The lawnmower defines a forward direction of movement and a plurality of flexible projections are mounted on the body forward of the cutting mechanism. The flexible projections extend downwardly from the body and are used to lift the bent grass forming a wheel track prior to cutting that grass.

The invention comprises, in another form thereof, a lawnmower that includes a body forming a downwardly opening enclosure. The body has a front edge, a back edge and two side edges which circumscribe the enclosure. An internal combustion engine or electric motor is mounted on the body. A cutting blade for cutting grass is operably coupled to the engine and is disposed within the enclosure. A plurality of wheels are mounted on the body and support the lawnmower. A handle is also mounted to the body and defines a forward direction of movement. A plurality of flexible projections extend downwardly from the body proximate the front edge and forward of the cutting blade. The flexible projections are used to lift bent grass forming a wheel track prior to cutting that grass.

The invention comprises, in yet another form thereof, a method of cutting grass. The method includes providing a lawn cutting instrument that has at least one wheel, cutting a first swath of grass with the lawn cutting instrument and bending a strip of uncut grass toward the ground proximate the first swath of grass with the at least one wheel while cutting the first swath of grass. The method also includes cutting a second swath of grass that includes the bent strip of uncut grass and at least partially lifting the bent strip of uncut grass with a plurality of downward projecting members immediately prior to cutting that portion of the second swath of grass.

The invention comprises, in still another form thereof, a method of retrofitting a lawnmower. The method includes providing at least one mounting block having a plurality of flexible projections extending therefrom and securing the mounting block to a front edge of the lawnmower with the flexible projections extending in downward direction.

The invention comprises, in yet another form thereof, a method of retrofitting a lawnmower which includes selling a retrofit kit having at least one bristle assembly with a plurality of flexible projections and providing information with the retrofit kit describing the attachment of the bristle assembly to a lawnmower. The information, e.g., installation instructions, may take the form of a simple diagram similar to that of either FIG. 1 or 4 of the present application.

An advantage of the present invention is that it can be used to raise bent grass forming a wheel track immediately prior to cutting the grass and solves this problem in a relatively inexpensive manner.

Another advantage is that it can be used to retrofit existing lawnmowers and other grass cutting instruments.

### BRIEF DESCRIPTION OF THE DRAWINGS

The above mentioned and other features and objects of this invention, and the manner of attaining them, will become more apparent and the invention itself will be better understood by reference to the following description of the invention taken in conjunction with the accompanying drawings, wherein:

FIG. 1 is a perspective view of a lawnmower in accordance with the present invention.

FIG. 2 is a schematic view of a lawn being mowed.

FIG. 3 is a side view of a portion of the lawnmower of FIG. 1.

FIG. 4 is a front view of a second embodiment of the invention.

FIG. 5 is a front view of a third embodiment of the invention.

Corresponding reference characters indicate corresponding parts throughout the several views. Although the exemplification set out herein illustrates the invention in several forms, the embodiments disclosed below are not intended to be exhaustive or to be construed as limiting the scope of the invention to the precise forms disclosed.

### DETAILED DESCRIPTION OF THE INVENTION

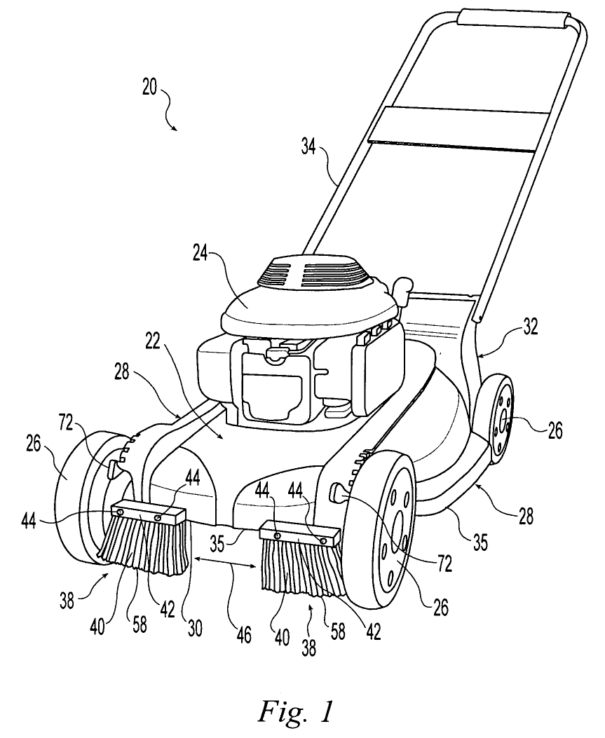

A lawnmower 20 in accordance with the present invention is shown in FIG. 1. Lawnmower 20 includes a main body, or deck, 22 on which an internal combustion engine 24 is mounted. Instead of using an internal combustion engine, an electric motor may also be employed as the power unit for mower 20. Mower 20 is supported by four wheels 26 with two wheels being mounted on each of the opposing side edges 28 of deck 22. Deck 22 also includes a front edge 30 and rear edge 32. Side edges 28, front edge 30 and rear edge 32 define a lower rim 35 of a downwardly opening enclosure formed by deck 22. A handle 34 extends upwardly from deck 22 and projects beyond rear edge 32. A rotary cutting blade 36 (FIG. 3) is located above lower rim 35 within the downwardly opening enclosure defined by deck 22 and is rotatably driven by engine 24. Although lawnmower 20 is mulching mower, the present invention may also be used with mowers having grass catchers and with machinery having other forms of grass cutting mechanisms.

A plurality of flexible projections 40 are attached to front edge 30 of lawnmower 20. In the illustrated embodiment, projections 40 are bristles that extend from a plastic mounting block 42. Two separate bristle assemblies 38, each having a mounting block 42 with a plurality of bristles 40 extending therefrom, are attached to front edge 30. Bristle assemblies 38 shown in FIG. 1 are similar to those used to form push brooms. The bristles 40 of each assembly 38 define a lateral width 41 and a longitudinal depth 43 wherein the depth 43 is greater than a single row of bristles but is less than lateral width 41.

Bristle assemblies 38 are secured to deck 22 using nut and bolt assemblies 44 that pass through openings in mounting blocks 42 and deck 22. As seen in FIG. 1, bristle assemblies 38 are each located near and extend laterally inwardly of one of the side edges 28 of deck 22 and wheels 26. A central opening 46 is defined between the two bristle assemblies 38 along front edge 30.

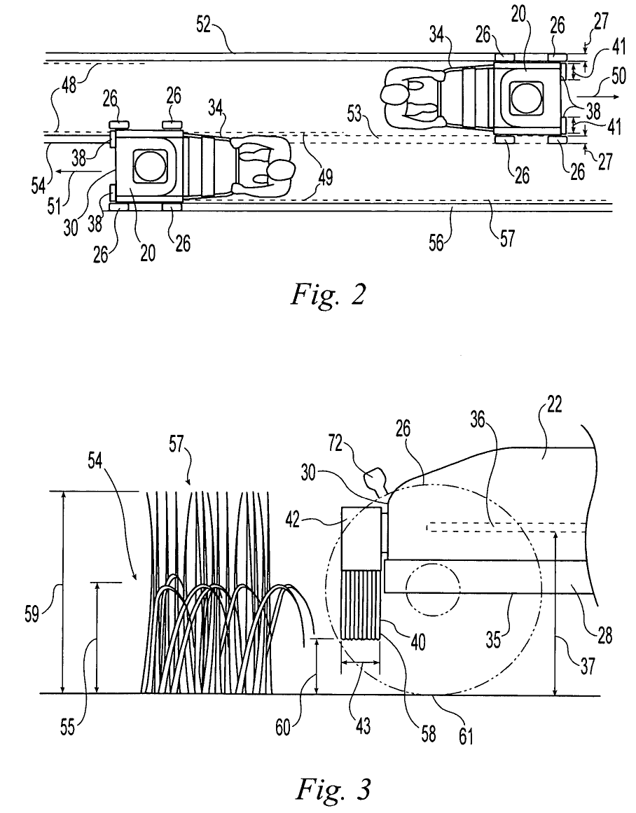

The function and operation of bristle assemblies 38 is best understood with reference to FIGS. 2 and 3. FIG. 2 is an overhead schematic representation of a person cutting a lawn. Initially, a first swath of grass 48 is cut as the operator pushes mower 20 in the forward direction indicated by arrow 50. As the first swath of grass 48 is being cut, wheels 26 on mower 20 bend two strips of grass downwardly to form wheel tracks. In FIG. 2, wheel track 52 is located on a portion of the lawn that has already been cut. Thus, when the bent grass forming wheel track 52 straightens up within a day or two, it will be the same height as the surrounding grass. The second wheel track 54 formed while cutting the first swath of grass 48 is located in an uncut portion of the lawn.

After cutting first swath 48, the operator cuts a second swath of grass 49 adjacent to the first swath 48 by pushing (or directing for self-propelled units) mower 20 in the direction indicated by arrow 51. When cutting the second swath 49, the operator aligns one of the bristle assemblies 38 with wheel track 54 so that bristles 40 will engage with and at least partially lift the uncut grass of wheel track 54 immediately prior to cutting that portion of the lawn with cutting blade 36. In FIG. 2, dashed lines 53 indicate that portion of wheel track 54 within second swath 49 that has already been cut by mower 20. As second swath 49 is being cut, another wheel track 56 adjacent to swath 49 is created by bending a strip of uncut grass toward the ground surface.

As seen in FIG. 3, projecting ends 58 of bristles 40 extend below cutting blade 36 and lower rim 35 and are located approximately one inch (2.54 cm) above the ground surface as indicated by dimensional line 60 in FIG. 3. In other words, projecting ends 58 are located one inch more or less above the lowermost surface 61 of wheels 26. To optimize performance, this height can be varied with the stiffness of grass being cut. Cutting blade 36 defines a cutting plane having a height indicated by dimension line 37 which is located below the height 59 of the uncut grass 57 and above the bent grass height 55 of wheel track 54. Bristles 40 are positioned so that bristle height 60 is less than wheel track height 55. Thus, as mower 20 advances, bristles 40 will engage the bent over grass forming wheel track 54 and at least partially lift this grass so that blade 36 will be able to cut the grass forming wheel track 54 at a level (as measured with the grass in an unbent condition) generally consistent with that of the surrounding lawn.

The width of the wheel tracks 52, 54, 56 is defined by the laterally extending width 27 of wheels 26. Bristle assemblies 38 each define a laterally extending bristle width 41 which is approximately four to five inches (10.2 to 12.7 cm). This width is greater than wheel width 27 so that the full width of the wheel track will be engaged by bristles 40. Although relatively stiff nylon bristles are used in the illustrated embodiment, alternative projections having a stiffness greater than grass could also be employed. For example, flexible projections 40 could be formed out of natural fiber bristles or polymeric materials other than nylon.

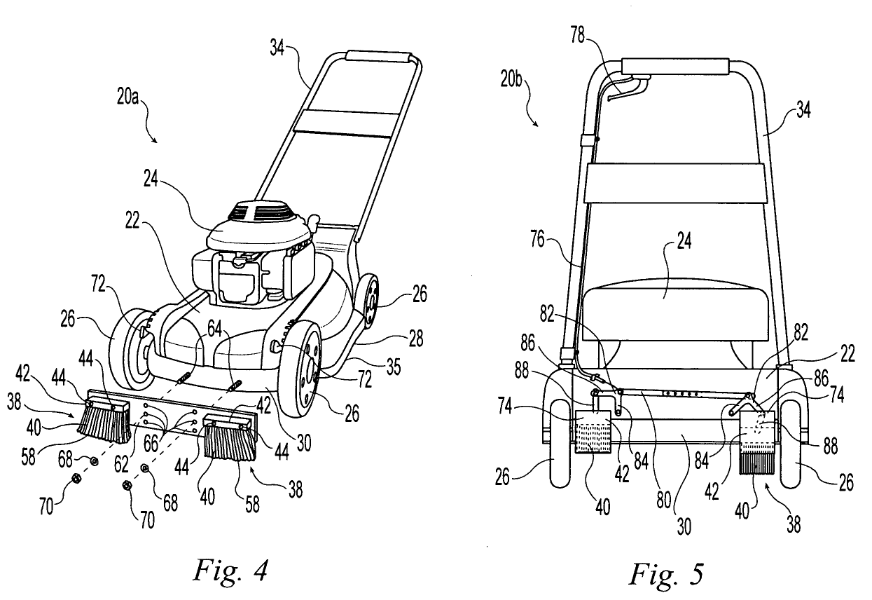

A second embodiment 20a of the present invention is shown in FIG. 4. Lawnmower 20a is similar to lawnmower 20 except for the manner in which bristle assemblies 38 are mounted to deck 22. In the second embodiment 20a, bristle assemblies 38 are mounted to a mounting plate 62 instead of directly to deck 22. Mounting plate 62 is a 1/16 inch (1.6 mm) thick steel material. Bolt shafts 64 project outwardly through holes in deck 22 and are inserted through a horizontally aligned pair of vertically spaced openings 66 located in mounting plate 62. Washers 68 and nuts 70 are used to secure mounting plate 62 together with attached bristle assemblies 38 to front edge 30 of deck 22. By using lock washers for washers 68, the washers will resist loosening that might otherwise be caused by the vibration of mower 20.

By providing mounting plate 62 with vertically spaced openings 66, the vertical position of mounting plate 62 and attached bristle assemblies 38 can be vertically adjusted. In the illustrated embodiment, openings 66 are vertically spaced apart by approximately 0.5 inches (1.3 cm). To adjust the height of bristles 40, all that is required is to untighten nuts 70, remove mounting plate 62, and then remount plate 62 to deck 22 by inserting bolt shafts 64 through a different pair of horizontally aligned openings 66. Lawnmowers typically provide for adjusting the height of the cutting blade by adjusting the height of the lawnmower deck above the ground surface using conventional wheel adjustment mechanisms 72. When the height of cutting blade 36 is adjusted using mechanisms 72, mounting plate 62 can also be adjusted to thereby position the projecting ends 58 of bristles 40 approximately one inch above the ground surface. For some grass varieties, alternative heights of the bristles may be desirable and the ability to vertically adjust the bristles allows the bristle height to be optimized for the grass being cut. It is also noted that instead of employing a single mounting plate 62, each of the bristle assemblies 38 could have a separate mounting plate with vertically spaced openings secured thereto to provide vertically adjustable bristle assemblies.

The embodiments 20, 20a, illustrated in FIGS. 1 and 4 are both well suited for mounting an existing lawnmower having a conventional construction. To retrofit a conventional lawnmower, all that is required is to drill holes in the deck 22 of the lawnmower and attach bristle assemblies 38 to the front edge 30 of deck 22. For lawnmower 20 of FIG. 1, four holes are drilled in deck 22 and two bristle assemblies 38 are attached as separate units. For lawnmower 20a of FIG. 4, only two holes are drilled in deck 22 and bristle assemblies 38 are indirectly attached to deck 22 by securing mounting plate 62 to front edge 30 as describe above.

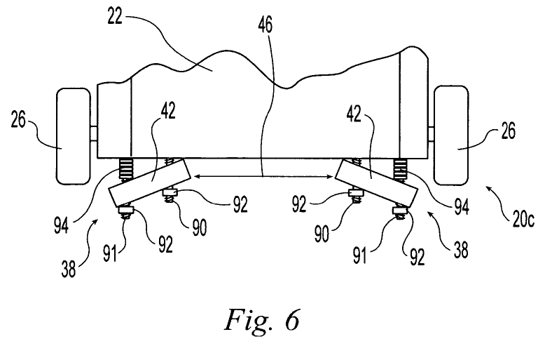

A third embodiment 20b of a lawnmower in accordance with the present invention is illustrated in FIG. 5. When cutting a swath of grass, it will generally only be necessary to raise the uncut grass of a single wheel track. As the operator cuts different swaths of grass across the lawn with this third embodiment 20b, the bristle assembly being used to raise the uncut wheel track will switch between the left and right bristle assemblies depending on the direction of travel. For example, when cutting first swath 48 in FIG. 3, as well as the swath that will be cut after swath 49, the left (as viewed by the operator) bristle assembly 38 will be used to raise the uncut grass of a wheel track, while the right bristle assembly 38 is used when cutting second swath 49.

The engagement of the grass with bristles 40 creates a drag force and increases the force required to propel the lawnmower. This increases the effort required by the operator, or, if the mower is self-propelled, increases the load on the engine and drive train of the mower. Furthermore, it may be desirable for yard debris, such as tree leaves, lying on the top of the uncut grass to pass under the front edge 30 of lower rim 35 so that it may be turned into mulch or collected with the grass clippings generated by the mowing operation. By providing a central opening 46 between bristle assemblies 38, the embodiments of FIGS. 1 and 4 cause less drag and allow the entry of more yard debris than a bristle assembly extending the full lateral width of front edge 30. Lawnmower 20b shown in FIG. 5 provides a mechanism by which only one of the bristle assemblies 38 will be engaged with the grass at any one time and thereby further reduces the drag and further enhances the ability of the mower to mulch and/or collect yard debris.

Lawnmower 20b includes two bristle assemblies 38 which are mounted in hollow, generally rectangular tubular housing members 74 mounted to front edge 30. Bristle assemblies 38 are vertically reciprocated within tubular housings 74 by a linkage assembly. The linkage assembly includes a Bowden cable 76 that extends between a manually operated grip 78 located on handle 34 and linkage bar 80. Operation of grip 78 horizontally moves linkage bar 80 via Bowden cable 76. The two ends of linkage bar 80 are connected to the centers of bell crank members 82. A first pivot arm 84 of each bell crank 82 is pivotally secured relative to deck 22 and a second actuating arm 86 is pivotally secured to one of the bristle assemblies 38 through an intermediate linkage 88. When movement of grip 78 moves linkage bar 80 laterally, one of the actuating arms 86 is pivoted upwardly while the other is pivoted downwardly, thereby raising one of the bristle assemblies 38 and lowering the other bristle assembly 38.

Thus, when the bristles of one of the assemblies 38 projects downwardly through open bottom end of its tubular housing 74, the other bristle assembly 38 will be retracted to within its tubular housing 74 and only one of the bristle assemblies 38 will be engaged with the grass. When mowing the lawn, the operator will use grip 78 to lower the appropriate bristle assembly 38 for each swath of grass.

A fourth embodiment 20c is shown in FIG. 6. This embodiment is generally similar to the embodiment of FIG. 1 but includes bristle assemblies 38 which have been positioned in a substantially V-shaped configuration to direct lawn debris towards center opening 46. In the embodiment illustrated in FIG. 6, each bristle assembly 38 is attached to deck 22 with an inboard bolt shaft 90 and an outboard bolt shaft 91. One or more spacing elements 94 are located on the outboard bolt shaft 91 between mounting blocks 42 and deck 22 to thereby angle bristle assemblies 38 inwardly toward central opening 46. In the illustrated embodiment, spacers 94 are common washers. Various alternative methods of orienting bristle assemblies 38 could also be employed. For example, mounting blocks 42 could have a wedge-shaped configuration when viewed from above obviating the need for separate spacing elements.

While this invention has been described as having an exemplary design, the present invention may be further modified within the spirit and scope of this disclosure. This application is therefore intended to cover any variations, uses, or adaptations of the invention using its general principles.

1. A lawnmower comprising:
a body;
a cutting mechanism mounted on said body and adapted to cut grass;
a plurality of wheels mounted on said body and supporting said lawnmower, said lawnmower defining a forward direction of movement and wherein said body defines a front edge, a back edge and two side edges; two of said plurality of wheels being located proximate each side edge of said body;
a plurality of flexible projections mounted on said body forward of said cutting mechanism and projecting downwardly from said body, said plurality of projections being vertically adjustable and including first and second pluralities of flexible projections mounted proximate said front edge of said body inboard of said wheels said first and second pluralities of projections being located proximate an opposite one of said side edges and defining a central opening along said front edge between said first and second pluralities of projections; and
a linkage assembly coupling said first and second pluralities of projections wherein said linkage assembly raises one of said first and second pluralities of projections as the other of said first and second plurality of projections is lowered.

2. (canceled)

3. The lawnmower of claim 1 wherein said first and second pluralities of flexible projections define a substantially V-shaped configuration whereby lawn debris is directed towards said central opening by said first and second pluralities.

4. The lawnmower of claim 1 wherein all of said flexible projections are located along said front edge of said body.

5-7. (canceled)

8. The lawnmower of claim 1 wherein said flexible projections are each elongate projections having a projecting end, said projecting ends being disposed approximately one inch above a lowermost surface of said wheels when said flexible projections are in a lowered position.

9. The lawnmower of claim 1 wherein each of said first and second pluralities of projections extend laterally and define a first width, said wheels each defining a laterally extending second width, each of said first widths being greater than said second width.

10. (canceled)

11. The lawnmower of claim 1 wherein said cutting mechanism defines a cutting plane and said plurality of flexible projections project below said cutting plane when in a lowered position.

12. A lawnmower comprising:
a body forming a downwardly opening enclosure, said body defining a front edge, a back edge and two side edges which circumscribe said enclosure;
a power unit mounted on said body;
a cutting blade operably coupled to said engine, said cutting blade disposed within said enclosure and adapted to cut grass;
a plurality of wheels mounted on said body and supporting said lawnmower, two of said plurality of wheels being located proximate each side edge of said body;
a handle mounted to said body and defining a forward direction of movement;
a plurality of flexible projections extending downwardly from said body, said plurality of flexible projections being disposed proximate said front edge and forward of said cutting blades said plurality of flexible projections including first and second pluralities of flexible projections mounted along said front edge inboard of said side edges, said first and second pluralities of flexible projections each being located proximate an opposite one of said side edges and defining a central opening along said front edge between said first and second pluralities of flexible projections; and
wherein each of said first and second pluralities of flexible projections are a plurality of bristles, each of said plurality of bristles arranged to define a lateral width and a longitudinal depth, each of said depths being greater than a single row of bristles, each of said widths being greater than each of said respective depths.

13. The lawnmower of claim 12 wherein said power unit is an internal combustion engine.

14. (canceled)

15. The lawnmower of claim 12 wherein said first and second pluralities of flexible projections are each mounted on said body by a pair of fasteners, one of each of said pair of fasteners having at least one spacer coupled thereto wherein said first and second pluralities define a substantially V-shaped configuration whereby lawn debris is directed towards said central opening by said first and second pluralities.

16. The lawnmower of claim 12 wherein said first and second pluralities of flexible projections each extend laterally and define a projection width, said wheels each defining a lateral wheel width; said projection widths being greater than said wheel widths.

17. The lawnmower of claim 12 wherein all of said flexible projections are located along said front edge of said body.

18. The lawnmower of claim 12 wherein said plurality of flexible projections are vertically adjustable.

19. The lawnmower of claim 18 further comprising a mounting plate, said plurality of projections being secured to said mounting plate, said mounting plate including a plurality of vertically spaced openings wherein selective vertical positioning of said plurality of projections is provided by inserting a fastener through a selected one of said vertically spaced openings.

20. The lawnmower of claim 18 further comprising:
a linkage assembly coupling said first and second pluralities of projections wherein said linkage assembly raises one of said first and second plurality of projections as the other of said first and second plurality of projections is lowered.

21. The lawnmower of claim 12 wherein said plurality of flexible projections each have a projecting end, said projecting ends being disposed approximately one inch above a lowermost surface of said wheels.

22-24. (canceled)

25. The lawnmower of claim 12 wherein said front edge, said back edge and said two side edges together define a lower rim of said enclosure, said cutting blade being positioned above said lower rim within said enclosure, said plurality of flexible projections extending below said lower rim.

26. A method of cutting grass, said method comprising:
providing a lawn cutting instrument, the lawn cutting instrument having at least one wheel;
mounting a first plurality of flexible projections extending downwardly from the lawn cutting instrument proximate a first side edge of the lawn cutting instrument and mounting a second plurality of flexible projections extending downwardly from the lawn cutting instrument proximate a second side edge of the lawn cutting instrument wherein a gap is defined between said first and second pluralities of flexible projections;
cutting a first swath of grass with the lawn cutting instrument;
bending a strip of uncut grass toward the ground proximate the first swath of grass with the at least one wheel while cutting the first swath of grass;
cutting a second swath of grass that includes the bent strip of uncut grass; and
aligning one of the first and second pluralities of flexible projections with the bent strip of uncut grass and at least partially lifting the bent strip of uncut grass with the aligned one of the first and second pluralities of flexible projections immediately prior to cutting that portion of the second swath of grass.

27. (canceled)

28. The method of claim 26 wherein the first and second plurality of flexible projections are each plurality of bristles mounted on the forward end of the lawn cutting instrument.

29. The method of claim 26 further comprising the step of adjusting the height of the first and second pluralities of flexible projections prior to said step of at least partially lifting the bent strip of uncut grass.

30. (canceled)

31. The method of claim 26 wherein the first and second pluralities of flexible projections are each a plurality of bristles and, when cutting the first and second swaths of grass, grass cuttings are circulated within the grass cutting instrument thereby reducing the average size of the grass cuttings and wherein the grass cuttings are deposited as mulch on the first and second swaths as the first and second swaths are being cut.

32-36. (canceled)
